(19) United States
(12) Patent Application Publication
(10) Pub. No.: US 2025/0190817 A1
(43) Pub. Date: Jun. 12, 2025

(54) METHODS AND SYSTEMS FOR ACCELERATED TREE LEARNING

(71) Applicant: Kinaxis Inc., Ottawa (CA)

(72) Inventors: Christopher WANG, Ottawa (CA); Zeng WANG, Ottawa (CA); Behrouz HAJI SOLEIMANI, Ottawa (CA)

(73) Assignee: KINAXIS INC., Ottawa (CA)

(21) Appl. No.: 18/978,043

(22) Filed: Dec. 12, 2024

Related U.S. Application Data
(60) Provisional application No. 63/609,073, filed on Dec. 12, 2023.
(60) Provisional application No. 63/627,258, filed on Jan. 31, 2024.

(51) Int. Cl. G06N 5/01

(52) U.S. Cl. CPC G06N 5/01

(57) ABSTRACT

Systems and methods disclose herein procedures for accelerated tree learning. In one class, the acceleration is based on self-adapting learning rates, while in another class, the acceleration is based on a plurality of learning rates, wherein each learning rate varies over the training; each learning rate increases linearly as a respective pseudo residual maintains a direction across sequential training iterations; and each learning rate decreases exponentially as the respective pseudo residual changes direction across sequential training iterations. The latter can be incorporated with other methodologies, such as momentum-augmented gradient boosting and Nesterov Accelerated Gradient Boosting. These systems and methods for accelerated tree learning exhibit a marked reduction in training time and resources required for gradient boosted trees.

The present application claims priority to: U.S. Provisional Patent Application No. 63/627,258, filed Jan. 31, 2024; and U.S. Provisional Patent Application No. 63/609,073, filed Dec. 12, 2023; the entirety of all of which are hereby incorporated by reference.

### BACKGROUND

When training the gradient boosted decision tree models, a goal is to reach the same level of accuracy using fewer number of trees, hence fewer number of training rounds. This directly enhances computer efficiency by reducing the time needed to train these types of machine learning models.

In addition, Gradient Boosting Machines (GBM) have arisen as a state of the art machine learning algorithm commonly used in both academia and industry. They have achieved top performance in a variety of topics such as click-rate prediction and fraud detection, as well as competitions such as Kaggle and KDDCup. Since their inception, they have undergone a variety of innovations to improve convergence speed, such as incorporating momentum, randomization, and binning. Gradient Boosting Machines (GBM) can be viewed as a form of learned gradient descent minimization in a functional space. On the other hand, powerful, deep learning optimization methods do not translate easily to the gradient boosting setting as they rely on the high dimensionality of the loss surface and the stochastic nature of minibatch gradient descent. Nonetheless, there is a need to translate the technical efficiencies of deep learning optimization methods to the gradient boosting setting, in order to provide technical improvements to the GBM.

### BRIEF SUMMARY

Disclosed herein are methods and systems for accelerating tree learning, in which multiple types of gradient descent optimization techniques are applied to gradient boosted trees (GBT). Such methods and systems may comprise momentum (cumulative gradients), ADAM/NADAM/RMSProp (second moment estimation), and learning rate scheduler/SAB/delta-bar-delta (self-adaptive learning rates). These techniques improve computational training performance over the standard GBT benchmarks, and thus reduce the processing time and resources needed for training gradient boosted decision tree models.

Systems and methods disclosed herein, also introduce novel adaptive learning rate techniques for faster training convergence. A technical process, called Delta-Bar-Delta (DBD), leverages four heuristics to improve steepest descent optimization, and can be adapted to the context of gradient boosting. Systems and methods disclose herein a novel procedure, herein called DBD Boosting, which demonstrates empirically-improved performance over a baseline Gradient Boosted Machine (GBM) model in a variety of regression and classification tasks. Furthermore, DBD Boosting can be incorporated with other methodologies, such as momentum-augmented gradient boosting and Nesterov Accelerated Gradient Boosting. Furthermore, DBD Boosting showcase pairwise improved performance. Methods and systems disclosed herein can incorporate adaptive learning rates on a per-sample basis to gradient Boosting machines and their variants.

In one aspect, a computing apparatus is provided. The computing apparatus includes a processor. The computing apparatus also includes a memory storing instructions that, when executed by the processor, configure the apparatus to: (a) obtain, by the processor, training data and testing data; (b) obtain, by the processor, one or more gradients with respect to previous prediction results. The computing apparatus also includes a memory storing instructions that, when executed by the processor, configure the apparatus to; (c) train, by the processor, a decision tree based on the one or more gradients; (d) apply, by the processor, a weighted sum of an output of each tree; (c) obtain, by the processor, an overall prediction result; repeat steps (b) through (c) until convergence, wherein in steps (b) through (c), the apparatus is configured to execute at least one of the following: (b.1) modify, by the processor, the one or more gradients with exponential smoothing; (b.2) modify, by the processor, the one or more gradients based on an exponential smoothing of the square of the one or more gradients; and (c.1) modify, by the processor, one or more learning rates by comparing with the previous prediction results.

The computing apparatus may be further configured to: (a) obtain, by the processor, the training data and the testing data; (b) obtain, by the processor, one or more gradients with respect to previous prediction results; (b.1) modify, by the processor, the one or more gradients with exponential smoothing; (c) train, by the processor, a decision tree based on the one or more gradients; (d) apply, by the processor, a weighted sum of an output of each tree; (e) obtain, by the processor, an overall prediction result; and repeat steps (b) through (e) until convergence.

The computing apparatus may be further configured to: (a) obtain, by the processor, the training data and the testing data; (b) obtain, by the processor, one or more gradients with respect to previous prediction results; (c) train, by the processor, a decision tree based on the one or more gradients; (c.1) modify, by the processor, one or more learning rates by comparing with the previous prediction results; (d) apply, by the processor, a weighted sum of an output of each tree; (e) obtain, by the processor, an overall prediction result; and repeat steps (b) through (c) until convergence.

The computing apparatus may be further configured to: (a) obtain, by the processor, the training data and the testing data; (b) obtain, by the processor, one or more gradients with respect to previous prediction results; (b.1) modify, by the processor, the one or more gradients with exponential smoothing; (c) train, by the processor, a decision tree based on the one or more gradients; (c.1) modify, by the processor, one or more learning rates by comparing with the previous prediction results; (d) apply, by the processor, a weighted sum of an output of each tree, (c) obtain, by the processor, an overall prediction result; and repeat steps (b) through (c) until convergence.

The computing apparatus may be further configured to: (a) obtain, by the processor, the training data and the testing data; (b) obtain, by the processor, one or more gradients with respect to previous prediction results; (b.2) modify, by the processor, the one or more gradients based on an exponential smoothing of the square of the one or more gradients; (c) train, by the processor, a decision tree based on the one or more gradients; (d) apply, by the processor, a weighted sum of an output of each tree; (c) obtain, by the processor, an overall prediction result; and repeat steps (b) through (c) until convergence. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: (a) obtain, by the processor, training data and testing data; (b) obtain, by the processor, one or more gradients with respect to previous prediction results. The computing apparatus also includes a memory storing instructions that, when executed by the processor, configure the apparatus to; (c) train, by the processor, a decision tree based on the one or more gradients; (d) apply, by the processor, a weighted sum of an output of each tree; (c) obtain, by the processor, an overall prediction result; repeat steps (b) through (e) until convergence, wherein in steps (b) through (c), the apparatus is configured to execute at least one of the following: (b.1) modify, by the processor, the one or more gradients with exponential smoothing; (b.2) modify, by the processor, the one or more gradients based on an exponential smoothing of the square of the one or more gradients; and (c.1) modify, by the processor, one or more learning rates by comparing with the previous prediction results.

The non-transitory computer-readable storage medium may also include instructions, that when executed, configure the computer to: (a) obtain, by the processor, the training data and the testing data; (b) obtain, by the processor, one or more gradients with respect to previous prediction results; (b.1) modify, by the processor, the one or more gradients with exponential smoothing; (c) train, by the processor, a decision tree based on the one or more gradients; (d) apply, by the processor, a weighted sum of an output of each tree; (e) obtain, by the processor, an overall prediction result; and repeat steps (b) through (c) until convergence.

The non-transitory computer-readable storage medium may also include instructions, that when executed, configure the computer to: (a) obtain, by the processor, the training data and the testing data; (b) obtain, by the processor, one or more gradients with respect to previous prediction results; (c) train, by the processor, a decision tree based on the one or more gradients; (c.1) modify, by the processor, one or more learning rates by comparing with the previous prediction results; (d) apply, by the processor, a weighted sum of an output of each tree; (c) obtain, by the processor, an overall prediction result; and repeat steps (b) through (c) until convergence.

The non-transitory computer-readable storage medium may also include instructions, that when executed, configure the computer to: (a) obtain, by the processor, the training data and the testing data; (b) obtain, by the processor, one or more gradients with respect to previous prediction results; (b.1) modify, by the processor, the one or more gradients with exponential smoothing; (c) train, by the processor, a decision tree based on the one or more gradients; (c.1) modify, by the processor, one or more learning rates by comparing with the previous prediction results; (d) apply, by the processor, a weighted sum of an output of each tree, (e) obtain, by the processor, an overall prediction result; and repeat steps (b) through (e) until convergence.

The non-transitory computer-readable storage medium may also include instructions, that when executed, configure the computer to: (a) obtain, by the processor, the training data and the testing data; (b) obtain, by the processor, one or more gradients with respect to previous prediction results; (b.2) modify, by the processor, the one or more gradients based on an exponential smoothing of the square of the one or more gradients; (c) train, by the processor, a decision tree based on the one or more gradients; (d) apply, by the processor, a weighted sum of an output of each tree; (e) obtain, by the processor, an overall prediction result; and repeat steps (b) through (c) until convergence. Other technical features may be readily apparent to one skilled in the art from the following figures, descriptions, and claims.

In one aspect, a computer-implemented method for accelerated tree learning is provided. The method includes: (a) obtaining, by a processor, training data and testing data; (b) obtaining, by the processor, one or more gradients with respect to previous prediction results; (c) training, by the processor, a decision tree based on the one or more gradients; (d) applying, by the processor, a weighted sum of an output of each tree; (c) obtaining, by the processor, an overall prediction result; repeating steps (b) through (e) until convergence, wherein steps (b) through (c) include at least one of the following: (b.1) modifying, by the processor, the one or more gradients with exponential smoothing; (b.2) modifying, by the processor, the one or more gradients based on an exponential smoothing of the square of the one or more gradients; and (c.1) modifying, by the processor, one or more learning rates by comparing with the previous prediction results.

The computer-implemented method may also include: (a) obtaining, by the processor, the training data and the testing data; (b) obtaining, by the processor, one or more gradients with respect to previous prediction results; (b.1) modifying, by the processor, the one or more gradients with exponential smoothing; (c) training, by the processor, a decision tree based on the one or more gradients; (d) applying, by the processor, a weighted sum of an output of each tree; (c) obtaining, by the processor, an overall prediction result; and repeating steps (b) through (c) until convergence.

The computer-implemented method may also include: (a) obtaining, by the processor, the training data and the testing data; (b) obtaining, by the processor, one or more gradients with respect to previous prediction results; (c) training, by the processor, a decision tree based on the one or more gradients; (c.1) modifying, by the processor, one or more learning rates by comparing with the previous prediction results; (d) applying, by the processor, a weighted sum of an output of each tree; (e) obtaining, by the processor, an overall prediction result; and repeating steps (b) through (c) until convergence.

The computer-implemented method may also include: (a) obtaining, by the processor, the training data and the testing data; (b) obtaining, by the processor, one or more gradients with respect to previous prediction results; (b.1) modifying, by the processor, the one or more gradients with exponential smoothing; (c) training, by the processor, a decision tree based on the one or more gradients; (c.1) modifying, by the processor, one or more learning rates by comparing with the previous prediction results; (d) applying, by the processor, a weighted sum of an output of each tree; (c) obtaining, by the processor, an overall prediction result; and repeating steps (b) through (c) until convergence.

The computer-implemented method may also include: (a) obtaining, by the processor, the training data and the testing data; (b) obtaining, by the processor, one or more gradients with respect to previous prediction results; (b.2) modifying, by the processor, the one or more gradients based on an exponential smoothing of the square of the one or more gradients; (c) training, by the processor, a decision tree based on the one or more gradients; (d) applying, by the processor, a weighted sum of an output of each tree; (c) obtaining, by the processor, an overall prediction result; and repeating steps (b) through (c) until convergence. Other technical features may be readily apparent to one skilled in the art from the following figures, descriptions, and claims.

In one aspect, a computing apparatus includes a processor. The computing apparatus also includes a memory storing instructions that, when executed by the processor, configure the apparatus to: update, by the processor, each learning rate of a respective parameter during each iteration of training a decision tree model, until a fully-trained model is obtained, wherein: each parameter has a unique learning rate; each learning rate varies over the training; each learning rate increases linearly as a respective pseudo residual maintains a direction across sequential training iterations; and each learning rate decreases exponentially as the respective pseudo residual changes direction across sequential training iterations.

The computing apparatus may be further configured to: receive, by the processor, a training data set, a learning rate, an increase rate applied to each learning rate, a decrease factor, a minimum learning rate (Γₘᵢₙ), a maximum learning rate (Γₘₐₓ), and a maximum number of iterations (M) for the training; initialize, by the processor, the decision tree model and a plurality of learning rates, each learning rate associated with a respective data point in the data set; iterate, by the processor, the following through the maximum number of iterations until the fully trained model is obtained: evaluate, by the processor, each pseudo residual associated with the respective data point; train, by the processor, the decision tree based on each pseudo residual; update, by the processor, each learning rate associated with the respective data point; and update the decision tree model as a weighted sum of a current state of all trees in the decision tree model.

The computing apparatus may be further configured to incorporate Momentum-augmented gradient boosting. The computing apparatus may also be further configured to incorporate Nesterov Accelerated Gradient Boosting. Other technical features may be readily apparent to one skilled in the art from the following figures, descriptions, and claims.

In one aspect, a non-transitory computer-readable storage medium is provided, the computer-readable storage medium including instructions that when executed by a computer, cause the computer to: update, by the processor, each learning rate of a respective parameter during each iteration of training a decision tree model, until a fully-trained model is obtained, wherein: each parameter has a unique learning rate; each learning rate varies over the training; each learning rate increases linearly as a respective pseudo residual maintains a direction across sequential training iterations; and each learning rate decreases exponentially as the respective pseudo residual changes direction across sequential training iterations.

The non-transitory computer-readable storage medium may also include instructions, that when executed, configure the computer to: receive, by the processor, a training data set, a learning rate, an increase rate applied to each learning rate, a decrease factor, a minimum learning rate (Γₘᵢₙ), a maximum learning rate (Γₘₐₓ), and a maximum number of iterations (M) for the training; initialize, by the processor, the decision tree model and a plurality of learning rates, each learning rate associated with a respective data point in the data set; iterate, by the processor, the following through the maximum number of iterations until the fully trained model is obtained: evaluate, by the processor, each pseudo residual associated with the respective data point; train, by the processor, the decision tree based on each pseudo residual; update, by the processor, each learning rate associated with the respective data point; and update the decision tree model as a weighted sum of a current state of all trees in the decision tree model.

The non-transitory computer-readable storage medium may also include instructions, that when executed, configure the computer to incorporate Momentum-augmented gradient boosting. The non-transitory computer-readable storage medium may also include instructions, that when executed, configure the computer to incorporate Nesterov Accelerated Gradient Boosting. Other technical features may be readily apparent to one skilled in the art from the following figures, descriptions, and claims.

In one aspect, a computer-implemented method for adapting gradient descent optimization to gradient boosting trees is provided. The method includes: updating, by a processor, each learning rate of a respective parameter during each iteration of training a decision tree model, until a fully-trained model is obtained, wherein: each parameter has a unique learning rate; each learning rate varies over the training; each learning rate increases linearly as a respective pseudo residual maintains a direction across sequential training iterations; and each learning rate decreases exponentially as the respective pseudo residual changes direction across sequential training iterations.

The computer-implemented method may also include: receiving, by the processor, a training data set, a learning rate (η), an increase rate (κ), a decrease factor (ϕ), a minimum learning rate (Γₘᵢₙ), a maximum learning rate (Γₘₐₓ), and a maximum number of iterations (M) in the training; initializing, by the processor, the decision tree model and a plurality of learning rates, each learning rate associated with a respective data point in the data set; iterating, by the processor, through the maximum number of iterations until the fully trained model is obtained, the following steps: evaluating, by the processor, each pseudo residual associated with the respective data point; training, by the processor, the decision tree based on each pseudo residual; updating, by the processor, each learning rate associated with the respective data point; and updating the decision tree model as a weighted sum of a current state of all trees in the decision tree model.

The computer-implemented method may also incorporate Momentum-augmented gradient boosting. The computer-implemented method may also incorporate Nesterov Accelerated Gradient Boosting. Other technical features may be readily apparent to one skilled in the art from the following figures, descriptions, and claims.

The details of one or more embodiments of the subject matter of this specification are set forth in the accompanying drawings and the description below. Other features, aspects, and advantages of the subject matter may become apparent from the description, the drawings, and the claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a system for accelerated tree learning in accordance with one embodiment.

FIG. 2 illustrates a block diagram in accordance with one embodiment.

FIG. 3 illustrates a block diagram in accordance with one embodiment.

FIG. 4 illustrates a block diagram in accordance with one embodiment.

FIG. 5 illustrates a block diagram in accordance with one embodiment.

FIG. 6 illustrates a block diagram in accordance with one embodiment.

FIG. 7 illustrates training performance accordance with one embodiment.

FIG. 8 illustrates testing performance in accordance with one embodiment.

FIG. 9A illustrates a 3-dimensional view of trajectories of various Gradient Descent Optimizers on the Beale Function, in accordance with one embodiment.

FIG. 9B illustrates a 2-dimensional view of trajectories of various Gradient Descent Optimizers on the Beale Function, in accordance with one embodiment.

FIG. 10 illustrates a block diagram in accordance with one embodiment of Delta-Bar-Delta boosting.

FIG. 11 illustrates a block diagram in accordance with one embodiment of Delta-Bar-Delta Momentum boosting.

FIG. 12 illustrates a block diagram in accordance with one embodiment of Delta-Bar-Delta Nesterov boosting.

FIG. 13 illustrates a block diagram in accordance with one embodiment of Delta-Bar-Delta boosting.

FIG. 14 illustrates a block diagram in accordance with one embodiment of Delta-Bar-Delta Momentum boosting.

FIG. 15 illustrates a block diagram in accordance with one embodiment of Delta-Bar-Delta Nesterov boosting.

FIG. 16 illustrates train loss versus number of iterations in accordance with one embodiment.

FIG. 17 illustrates test loss versus number of iterations in accordance with one embodiment.

FIG. 18A illustrates training learning rate versus number of iterations on a training set in accordance with one embodiment.

FIG. 18B illustrates training learning rate versus number of iterations on a training set in accordance with one embodiment.

FIG. 18C illustrates training learning rate versus number of iterations on a training set in accordance with one embodiment.

FIG. 18D illustrates training learning rate versus number of iterations on a training set in accordance with one embodiment.

FIG. 18E illustrates training learning rate versus number of iterations on a training set in accordance with one embodiment.

FIG. 18F illustrates training learning rate versus number of iterations on a training set in accordance with one embodiment.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium can include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a Blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

As used herein, a “software engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows that can be performed by an apparatus, can also be implemented as a graphics processing unit (GPU).

Computers suitable for the execution of a computer program include, by way of example, general or special purpose microprocessors or both, or any other kind of central processing unit. Generally, a central processing unit receives instructions and data from a read-only memory or a random access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

To provide for interaction with a user, embodiments of the subject matter described herein can be implemented on a computer having a display device for displaying information to the user and input devices by which the user can provide input to the computer (for example, a keyboard, a pointing device such as a mouse or a trackball, etc.). Other kinds of devices can be used to provide for interaction with a user. Feedback provided to the user can include sensory feedback (e.g., visual feedback, auditory feedback, or tactile feedback). Input from the user can be received in any form, including acoustic, speech, or tactile input. Furthermore, there can be interaction between a user and a computer by way of exchange of documents between the computer and a device used by the user. As an example, a computer can send web pages to a web browser on a user's client device in response to requests received from the web browser.

Embodiments of the subject matter described in this specification can be implemented in a computing system that includes: a front end component (e.g., a client computer having a graphical user interface or a Web browser through which a user can interact with an implementation of the subject matter described herein); or a middleware component (e.g., an application server); or a back end component (e.g. a data server); or any combination of one or more such back end, middleware, or front end components. The components of the system can be interconnected by any form or medium of digital data communication, e.g., a communication network. Non-limiting examples of communication networks include a local area network (“LAN”) and a wide area network (“WAN”).

The computing system can include clients and servers. A client and server are generally remote from each other and typically interact through a communication network. The relationship of client and server arises by virtue of computer programs running on the respective computers and having a client-server relationship to each other.

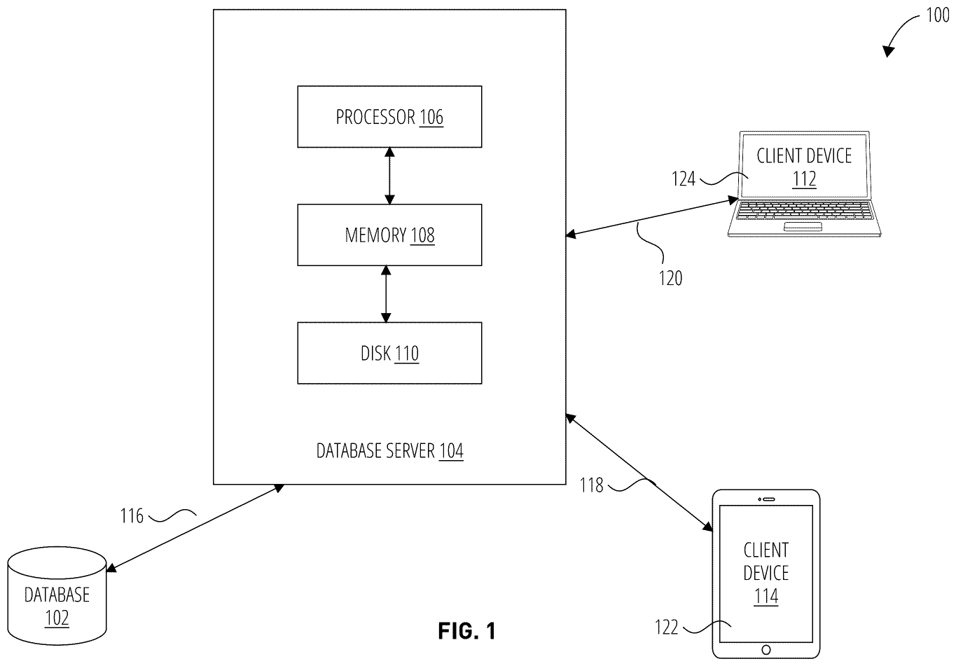

FIG. 1 illustrates an example of a system 100 for accelerated tree learning.

System 100 includes a database server 104, a database 102, and client devices 112 and 114. Database server 104 can include a memory 108, a disk 110, and one or more processors 106. In some embodiments, memory 108 can be volatile memory, compared with disk 110 which can be non-volatile memory. In some embodiments, database server 104 can communicate with database 102 using interface 116. Database 102 can be a versioned database or a database that does not support versioning. While database 102 is illustrated as separate from database server 104, database 102 can also be integrated into database server 104, either as a separate component within database server 104, or as part of at least one of memory 108 and disk 110. A versioned database can refer to a database which provides numerous complete delta-based copies of an entire database. Each complete database copy represents a version. Versioned databases can be used for numerous purposes, including simulation and collaborative decision-making.

System 100 can also include additional features and/or functionality. For example, system 100 can also include additional storage (removable and/or non-removable) including, but not limited to, magnetic or optical disks or tape. Such additional storage is illustrated in FIG. 1 by memory 108 and disk 110. Storage media can include volatile and nonvolatile, removable and non-removable media implemented in any method or technology for storage of information such as computer-readable instructions, data structures, program modules or other data. Memory 108 and disk 110 are examples of non-transitory computer-readable storage media. Non-transitory computer-readable media also includes, but is not limited to, Random Access Memory (RAM), Read-Only Memory (ROM), Electrically Erasable Programmable Read-Only Memory (EEPROM), flash memory and/or other memory technology, Compact Disc Read-Only Memory (CD-ROM), digital versatile discs (DVD), and/or other optical storage, magnetic cassettes, magnetic tape, magnetic disk storage or other magnetic storage devices, and/or any other medium which can be used to store the desired information and which can be accessed by system 100. Any such non-transitory computer-readable storage media can be part of system 100.

System 100 can also include interfaces 116, 118 and 120. Interfaces 116, 118 and 120 can allow components of system 100 to communicate with each other and with other devices. For example, database server 104 can communicate with database 102 using interface 116. Database server 104 can also communicate with client devices 112 and 114 via interfaces 120 and 118, respectively. Client devices 112 and 114 can be different types of client devices; for example, client device 112 can be a desktop or laptop, whereas client device 114 can be a mobile device such as a smartphone or tablet with a smaller display. Non-limiting example interfaces 116, 118 and 120 can include wired communication links such as a wired network or direct-wired connection, and wireless communication links such as cellular, radio frequency (RF), infrared and/or other wireless communication links. Interfaces 116, 118 and 120 can allow database server 104 to communicate with client devices 112 and 114 over various network types. Non-limiting example network types can include Fibre Channel, small computer system interface (SCSI), Bluetooth, Ethernet, Wi-fi, Infrared Data Association (IrDA), Local area networks (LAN), Wireless Local area networks (WLAN), wide area networks (WAN) such as the Internet, serial, and universal serial bus (USB). The various network types to which interfaces 116, 118 and 120 can connect can run a plurality of network protocols including, but not limited to Transmission Control Protocol (TCP), Internet Protocol (IP), real-time transport protocol (RTP), realtime transport control protocol (RTCP), file transfer protocol (FTP), and hypertext transfer protocol (HTTP).

Using interface 116, database server 104 can retrieve data from database 102. The retrieved data can be saved in disk 110 or memory 108. In some cases, database server 104 can also comprise a web server, and can format resources into a format suitable to be displayed on a web browser. Database server 104 can then send requested data to client devices 112 and 114 via interfaces 120 and 118, respectively, to be displayed on applications 122 and 124. Applications 122 and 124 can be a web browser or other application running on client devices 112 and 114.

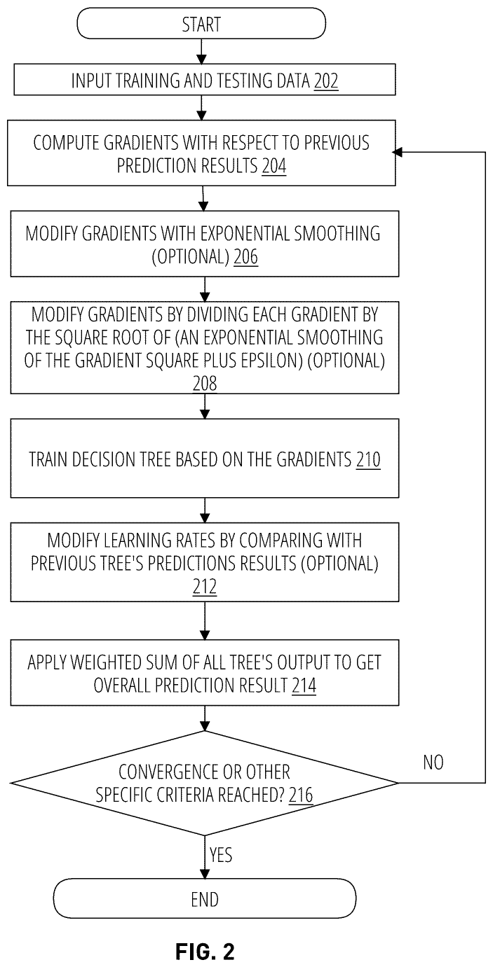

Systems and methods for accelerated tree learning can comprise the following elements: history of gradients on a per data point per iteration basis; history of exponentially smoothed gradients on a per data point per iteration basis; history of exponentially smoothed gradients squared on a per data point per iteration basis; history of learning rates on a per data point per iteration basis; one or more adaptive coefficients for exponential smoothing per iteration; and one or more adaptive coefficients for learning rate per iteration. These elements can be combined as illustrated in FIG. 2.

FIG. 2 illustrates a block diagram in accordance with one embodiment. At 202, training data and testing data are acquired. At block 204, gradients are computed with respect to previous prediction results. Here, errors with respect to current predictions are acquired. These errors are then considered the gradients (pseudo residuals) to be predicted by the tree in the current iteration.

Next, in a first optional step at block 206 these errors (that is, gradients) can then be modified based on the exponential smoothing of previous prediction results.

In a subsequent second optional step at block 208, these gradients can then be modified by dividing by the square root of exponential smoothing of previous prediction results squared plus epsilon (where epsilon is of the order 10⁻⁸). In some embodiments, the following expressions can be used:

$${E [ {g}^{2} ]}_{t} = γ {E [ {g}^{2} ]}_{t = 1} + ( 1 + γ ) {g}_{t}^{2} \\ {θ}_{t + 1} = {θ}_{t} - \frac{η}{\sqrt{{E [ {g}^{2} ]}_{t} + ϵ}} {g}_{t}$$

In the above, ‘E’ is an exponentially smoothed term for g² (g==gradient). And when updating the objective parameter θ, the actual gradient gₜ is divided by the square root of (E+∈), where ‘∈’ is of the order 10⁻⁸. Thus, in block 208, there is exponential smoothing of the gradient-squared (that is, g²), along with modification of the gradient by dividing by the square root of the exponential smoothing of g²; ‘∈’ is of the order 10⁻⁸ can be included within the square root to offset a situation where ‘E’ is zero.

In a next step at block 210, a decision tree is trained based on the (modified) gradients.

Next, in a third optional step at block 212, the learning rates can then be modified by comparing current residuals with the previous tree's prediction results. In some embodiments of the third optional step, the learning rates can be modified using any one of the following approaches: “SAB” and “SAB with momentum”. These terms are explained as follows. SAB is self-adaptive learning rate when combined with a regular GBT. SAB momentum is self-adaptive learning rate when combined with a momentum-based GBT. Since each of GBT and momentum-based GBT are two different variants of GBT, it follows that only one of their SAB variants can be used per model.

At block 214, all tree's output are multiplied by their respective learning rates per data point and sum over all trees to get overall prediction. The process returns to block 204, and the sequence is repeated until there is convergence or some other specific criteria is reached.

In FIG. 2, all three optional steps are independent of each other. Furthermore, in some embodiments, at least one optional step is included in the overall block diagram. Where all three optional steps (i.e. Block 206, block 208 and block 212) are not used, and only blocks 204, 210 and 214 are used, the result is a GBT.

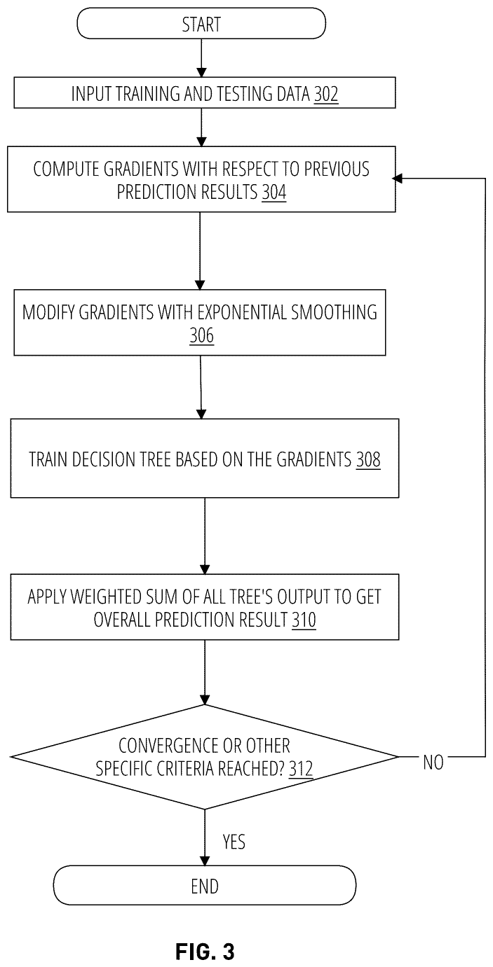

FIG. 3 illustrates a block diagram in accordance with one embodiment, in which momentum is applied. FIG. 3 may be derived from FIG. 2 as follows: Optional block 206 is kept, while block 208 and block 212 are not used.

At block 302, training data and testing data are acquired. At block 304, gradients are computed with respect to previous prediction results. Here, errors with respect to current predictions are acquired. These errors are then considered the gradients (pseudo residuals) to be predicted by the tree in the current iteration.

Next, at block 306 these errors (that is, gradients) can then be modified based on the exponential smoothing of previous prediction results. This refers to the application of momentum to trees.

In a next step at block 308, a decision tree is trained based on the (modified) gradients.

At block 310, all tree's output are multiplied by their respective learning rates per data point and sum over all trees to get overall prediction. The process returns to block 304, and the sequence is repeated until there is convergence or some other specific criteria is reached.

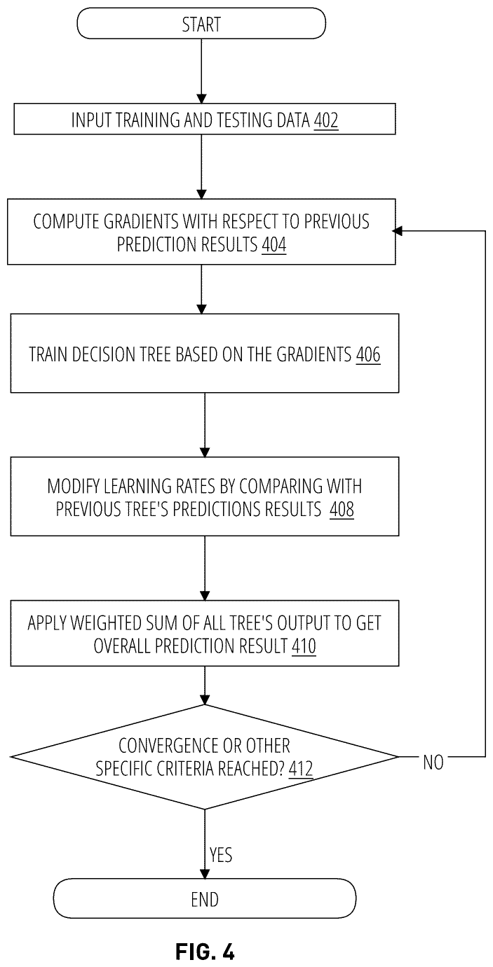

FIG. 4 illustrates a block diagram in accordance with one embodiment, in which SAB is applied—that is self-adaptive learning rate when applied to GBT. FIG. 4 may be derived from FIG. 2 as follows: Optional block 212 is kept, while block 206 and block 208 are not used.

At block 402, training data and testing data are acquired. At block 404, gradients are computed with respect to previous prediction results. Here, errors with respect to current predictions are acquired. These errors are then considered the gradients (pseudo residuals) to be predicted by the tree in the current iteration.

In a next step at block 406, a decision tree is trained based on the (modified) gradients. Next, at block 410, the learning rates can then be modified by comparing current residuals with the previous tree's prediction results.

At block 410, all tree's output are multiplied by their respective learning rates per data point and sum over all trees to get overall prediction. The process returns to block 404, and the sequence is repeated until there is convergence or some other specific criteria is reached.

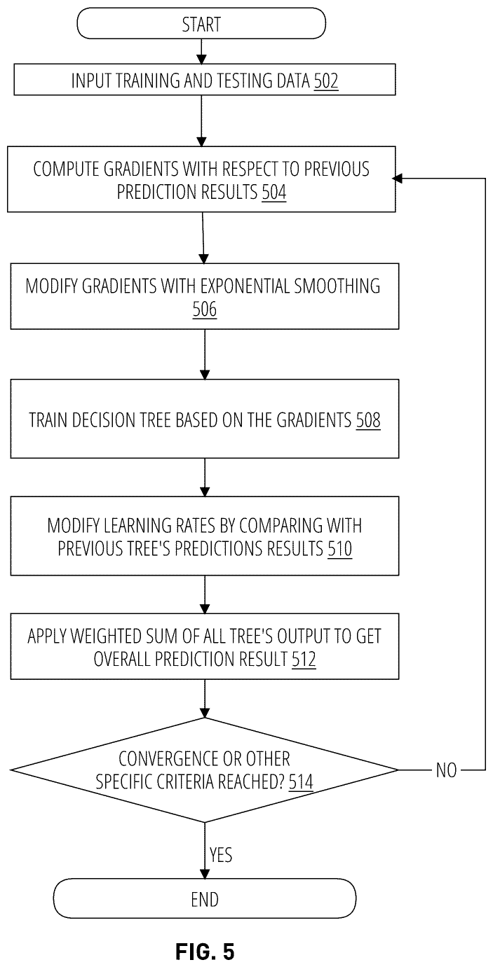

FIG. 5 illustrates a block diagram in accordance with one embodiment, in which SAB-momentum is applied. FIG. 5 may be derived from FIG. 2 as follows: Optional block 208 and block 212 are kept, while optional block 206 is not used.

At 502, training data and testing data are acquired. At block 504, gradients are computed with respect to previous prediction results. Here, errors with respect to current predictions are acquired. These errors are then considered the gradients (pseudo residuals) to be predicted by the tree in the current iteration.

Next, at block 506 these errors (that is, gradients) can then be modified based on the exponential smoothing of previous prediction results.

In a next step at block 508, a decision tree is trained based on the (modified) gradients.

Next, at block 510, the learning rates can then be modified by comparing current residuals with the previous tree's prediction results. In some embodiments of block 510, the learning rates can be modified using any one of the following approaches: “SAB” and “SAB with momentum”. While SAB is short for “self-adaptive back propagation”, in the case of gradient boosting, there is no back propagation step. Therefore, SAB refers to just “self-adaptive learning rate” on a per data point per iteration basis. These terms are explained as follows. SAB is self-adaptive learning rate when combined with a regular GBT. SAB momentum is self-adaptive learning rate when combined with a momentum-based GBT. Since each of GBT and momentum-based GBT are two different variants of GBT, it follows that only one of their SAB variants can be used per model.

At block 512, all tree's output are multiplied by their respective learning rates per data point and sum over all trees to get overall prediction. The process returns to block 504, and the sequence is repeated until there is convergence or some other specific criteria is reached.

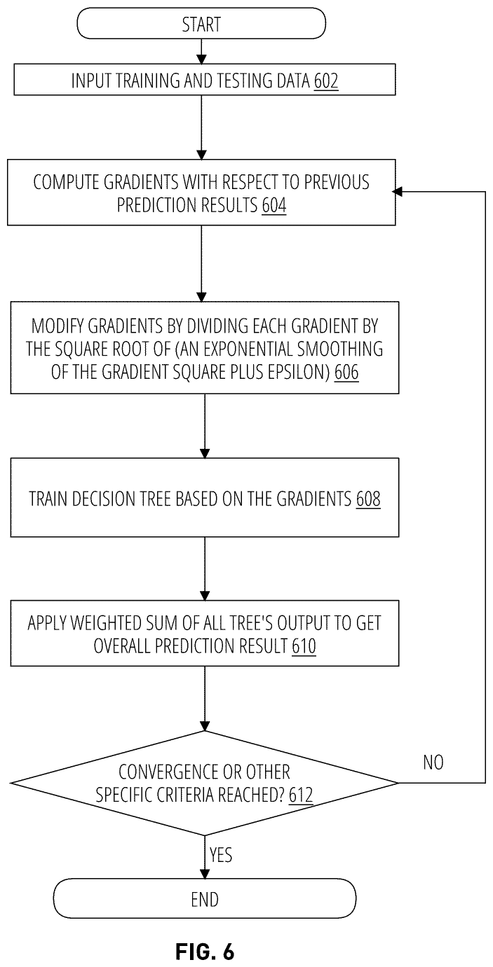

FIG. 6 illustrates a block diagram in accordance with one embodiment. FIG. 6 may be derived from FIG. 2 as follows: Optional block 208 is kept, while optional blocks 206 and 212 are not used.

At 602, training data and testing data are acquired. At block 604, gradients are computed with respect to previous prediction results. Here, errors with respect to current predictions are acquired. These errors are then considered the gradients (pseudo residuals) to be predicted by the tree in the current iteration.

In a subsequent block 606, these gradients can then be modified by dividing by the square root of exponential smoothing of previous prediction results squared plus epsilon (where epsilon is of the order 10⁻⁸). In some embodiments, the following expressions can be used:

$${E [ {g}^{2} ]}_{t} = γ {E [ {g}^{2} ]}_{t = 1} + ( 1 + γ ) {g}_{t}^{2} \\ {θ}_{t + 1} = {θ}_{t} - \frac{η}{\sqrt{{E [ {g}^{2} ]}_{t} + ϵ}} {g}_{t}$$

In the above, ‘E’ is an exponentially smoothed term for g² (g==gradient). And when updating the objective parameter θ, the actual gradient gₜ is divided by the square root of (E+∈), where ‘E’ is of the order 10⁻⁸. Thus, in block 606, there is exponential smoothing of the gradient-squared (that is, g²), along with modification of the gradient by dividing by the square root of the exponential smoothing of g²; ‘∈’ is of the order 10⁻⁸ can be included within the square root to offset a situation where ‘E’ is zero.

In a next step at block 608, a decision tree is trained based on the (modified) gradients. At block 214, all tree's output are multiplied by their respective learning rates per data point and sum over all trees to get overall prediction. The process returns to block 204, and the sequence is repeated until there is convergence or some other specific criteria is reached.

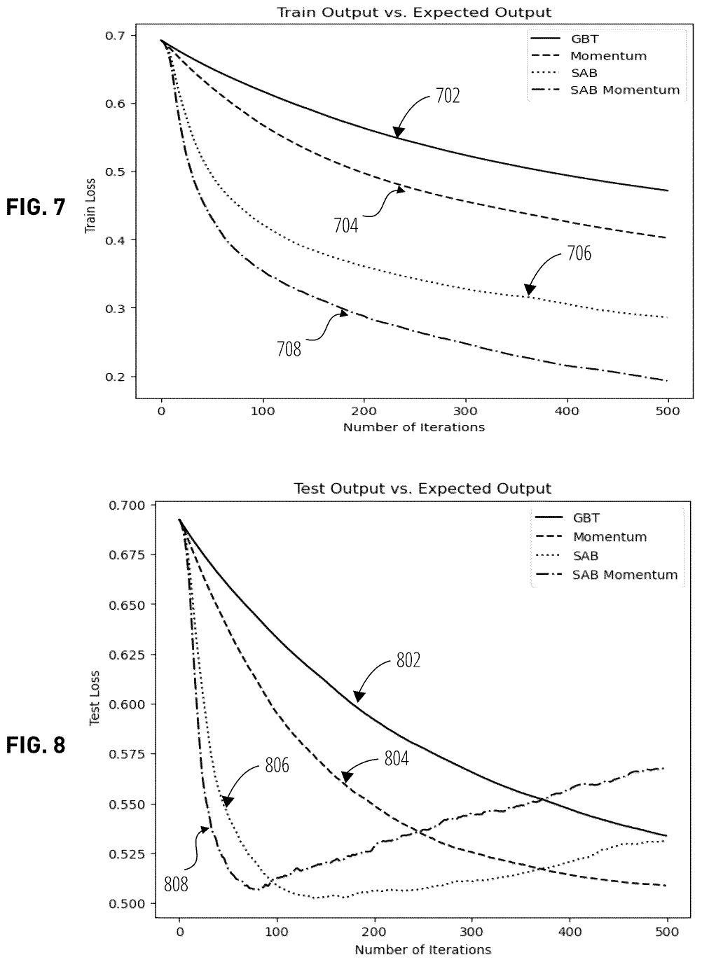

FIG. 7-FIG. 8 demonstrate performance improvements of the disclosed systems and methods for accelerated tree learning compared to benchmark models.

FIG. 7 demonstrates the loss curves for different models during training time, in which GBT (702) is the benchmark model. Each loss curve in FIG. 7 indicates the amount of error between predicted output of the model and the expected output from the dataset. The lower the loss curve, the better.

As shown in FIG. 7, three models used in the disclosed systems and method of accelerated tree learning (Momentum 704, SAB 706 and SAB Momentum 708) each show a marked improvement over the benchmark GBT 702 model. The SAB Momentum 708 model is the best in terms of training. For example, a train loss of 0.5 is obtained after about 50 iterations by SAB Momentum 708; after about 90 iterations by SAB 706; after about 270 iterations by Momentum 704; and after about 500 iterations by GBT 702. This is a clear illustration of the enhancement of computer efficiency and resources that results from the processes disclosed herein, including the exemplary processes shown in FIG. 2-FIG. 6.

While SAB is short for “self-adaptive back propagation”, in the case of gradient boosting, there is no back propagation step. Therefore, SAB refers to just “self-adaptive learning rate” on a per data point per iteration basis.

SAB Momentum 708 incorporates both the idea of “self-adaptive learning rate” and “momentum”. That is, at every iteration, the learning rate can either be increased or decreased based on the direction of the gradients (this is the SAB part). After that, the newly-scaled learning rate is combined with the history/previous learning rates. Since smoothing from momentum is used, this combination step is an exponentially smoothed average (this is the momentum part).

FIG. 8 demonstrates the loss curves for different models during testing time (using data samples that were never seen before by the model during training time).

In FIG. 8, each loss curve indicates the amount of error between predicted output of the model and the expected output from the dataset. The lower the loss curve, the better. As shown in FIG. 8, the three models used in the disclosed systems and method of accelerated tree learning (Momentum 804, SAB 806, SAB Momentum 808) each show a marked improvement over the benchmark GBT 802 model over the first 300 iterations or so, with the SAB Momentum 808 model being the best in terms of training.

In FIG. 8, while the loss curve of both versions of the SAB model (that is SAB 806 and SAB Momentum 808) eventually rise above the loss curve of GBT 802, each SAB model (806 and 808) already reaches a minimum loss at a much earlier iteration. For example, SAB Momentum 808 reaches a minimum at about 80 iterations, while SAB 806 reaches a minimum at about 120 iterations. This means that the performance of the each SAB model (that is, SAB 806 and SAB Momentum 808) matches GBT, but it uses only one-fifth of the iterations used by GBT. This is a clear illustration of the enhancement of computer efficiency and resources that results from the processes disclosed herein, including the exemplary processes shown in FIG. 2-FIG. 6.

### Delta-Bar-Delta Boosting (DBD Boosting)

Before discussing DBD Boosting, a summary of the shortcomings of other methods is provided below.

### Gradient Boosting Trees (GBT)

Consider a supervised learning problem with n total samples D={(x₁, y₁), . . . , (xₙ, yₙ)}, where xᵢ∈R^{d} is a d-dimensional input feature vector for the i-th sample, and yᵢ∈R is the accompanying label. Note that R^{d} represents a ‘d’-dimensional array of real numbers. A Gradient Boosting Machine is a function F:R^{d}→R that is an additive combination of the form:

$$f ( x ) = {\sum }_{m = 1}^{M} {η}^{m} {f}^{m} ( x ) \qquad ( Eq . 1 )$$

where f^{m}(x)∈ [symbol] is drawn from a class of weak learners and η^{m} is the step-size coefficient of the m-th weak learner. Common weak learners drawn from [symbol] include linear models, tree stumps, or regression trees while n are often constant values or found through line search. To generate this ensemble, an empirical cost function C, is minimized:

$$CY , F ( x ) ) = \frac{1}{n} {\sum }_{i = 1}^{n} L ( {y}_{i} , F ( {x}_{i} ) )$$

where L is a loss function that determines performance, often Negative Log Likelihood (NLL) for classification and Mean Squared Error (MSE) for regression. Gradient Boosting Machines (GBM) can be viewed as a form of learned gradient descent minimization in a functional space.

### Gradient Descent Optimization

Two classes of gradient optimization improvements have arisen: momentum-based methods and adaptive learning rate methods. Momentum-based methods seek to accelerate convergence by propagating gradient information of previous iterations forward through a momentum term. The Nesterov Accelerated Gradient (NAG) is one such method that provides strong convergence guarantees and has been adapted to the gradient boosting setting. In contrast, adaptive learning rate methods seek to adapt the step size of each parameter individually for each descent step. These methods, which encompass algorithms like Adagrad and RMSProp, seek to control the step size of each individual parameter to handle gradient sign oscillations. ADAM, an optimizer, combines both momentum and adaptive learning rates and can achieve strong convergence performance. While powerful, deep learning optimization methods do not translate easily to the gradient boosting setting as they rely on the high dimensionality of the loss surface and the stochastic nature of minibatch gradient descent. There is a need for to adapt the powerful methods of deep learning optimization to gradient boosting trees, in order to improve Gradient Boosting Machines (GBM).

### Delta-Bar-Delta Boosting

DBD Boosting is a formalization of four heuristics to improve steepest-descent optimization. It is characterized by the following equation:

$${η}_{i}^{t} = \{ \begin{matrix}min ( {η}_{i}^{t - 1} + κ , {Γ}_{max} ) & if \frac{\partial {L}^{t}}{\partial {ω}_{i}^{t}} \frac{\partial {L}^{t - 1}}{\partial {ω}^{t - 1}} > 0 \\ max ( ϕ {η}_{i}^{t - 1} , {Γ}_{min} ) & if \frac{\partial {L}^{t}}{\partial {ω}_{i}^{t}} \frac{\partial {L}^{t - 1}}{\partial {ω}_{t}^{t - 1}} < 0 \\ {η}_{i}^{t - 1} & otherwise\end{matrix}$$

where ηᵢ^{t} is a per parameter learning rate at step t for weight ωᵢ, κ>0 is a linear increase rate, 0<ϕ<1 is an exponential decrease factor. ηᵢ^{t} is bound between maximum learning rate Γₘₐₓ and minimum learning Γₘᵢₙ such that Γₘᵢₙ≤ηᵢ^{t}≤Γₘₐₓ to stabilize training of ωᵢ and prevent exploding gradients. L is a loss function; ∂L^{t}/∂ωᵢ^{t} is a gradient of the loss function, at step ‘t’, with respect to weight ωᵢ at step ‘t’. Thus, the learning rate ηᵢ^{t} increases when gradient ∂L^{t}/∂ωᵢ^{t} maintains its sign over successive iterations. The learning rate ηᵢ^{t} decreases when gradient ∂L^{t}/∂ωᵢ^{t} changes its sign over successive iterations. And finally, the learning rate ηᵢ^{t} is unchanged when the gradient ∂L^{t}/∂ωᵢ^{t} is zero over successive iterations.

DBD boosting may be based on the following:
(1) Each parameter should have an individual learning rate. A globally-chosen learning rate may not be suitable across all dimensions of the loss landscape. DBD Boosting differs from the accelerated tree-learning methods illustrated in FIG. 2-FIG. 6, in part, due to the nature of the learning rate. In the embodiments illustrated in FIG. 2-FIG. 6, the same learning rates are used globally across all data points, whereas in DBD Boosting, a separate learning rate is used for each data point.
(2) Each learning rate should vary over the course of training. A loss landscape involves different geometries depending on the local region of a particular parameter.
(3) Linearly increase the learning rate when the gradient shares signs across training iterations. When past gradients share a sign then there is agreement on the direction; thus the learning rate can be increased. This is reflected above by increasing the learning rate ηᵢ^{t} from the previous learning rate ηᵢ^{t-1} with κ, a positive learning rate, up to a maximum value of Γₘₐₓ.
(4) Exponentially decrease the learning rate when the gradient alternates signs. When the sign flips then it is likely that the parameter is caught in a region of high curvature. This is reflected above by decreasing the learning rate ηᵢ^{t} from the previous learning rate ηᵢ^{t-1} by a factor of ϕ (where 0<ϕ<1), down to a minimum value of Γₘᵢₙ.

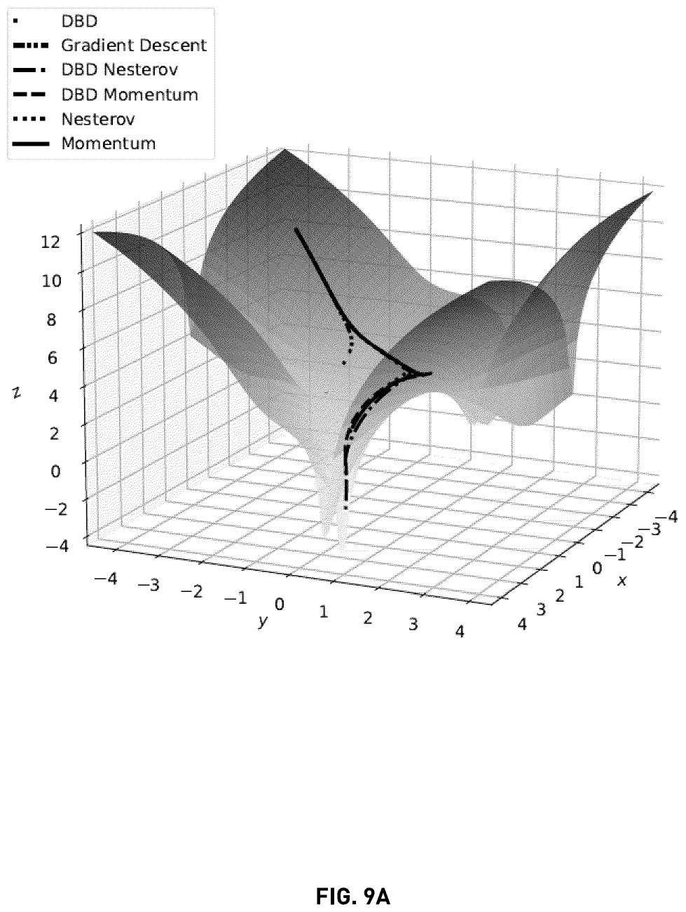

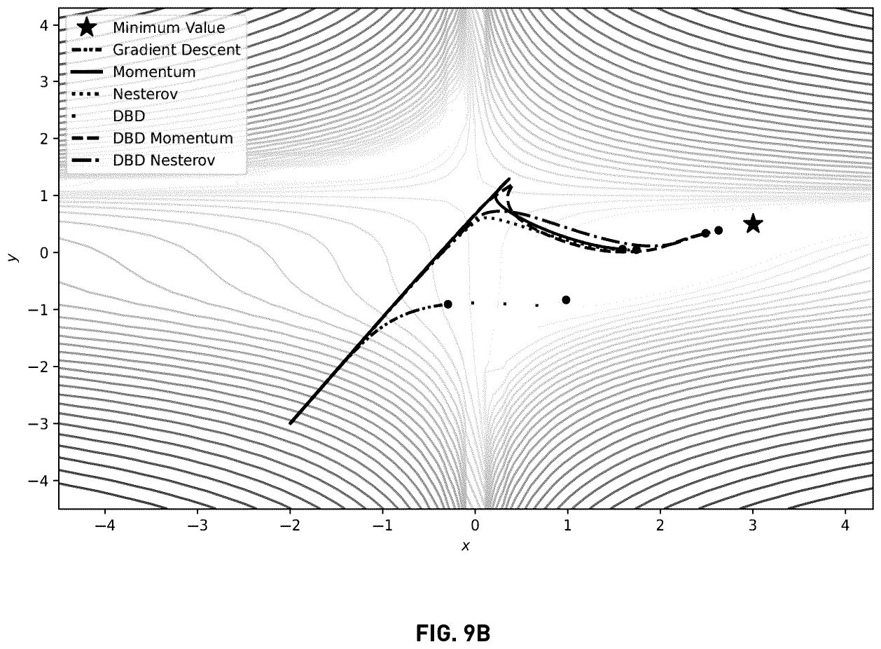

FIG. 9A illustrates a 3-dimensional view of trajectories of various Gradient Descent Optimizers on the Beale Function, in accordance with one embodiment of DBD Boosting, while FIG. 9B illustrates a 2-dimensional view of trajectories of various Gradient Descent Optimizers on the Beale Function, in accordance with one embodiment DBD Boosting.

FIG. 9A and FIG. 9B illustrate trajectories of Delta-Bar-Delta on the Beale Function, a standard gradient descent task. When augmenting existing momentum-based descent algorithms, systems and methods disclosed herein show improved convergence speed over the non-augmented counterparts. The DBD heuristics are extended to the gradient boosting setting by considering the predicted gradient of a sample xi rather than the gradient of a parameter. Consequently, the instant model is no longer a simple linear combination, but instead accounts for the predicted geometry of the loss landscape.

Algorithm 1 is an embodiment of DBD Boosting, with similar augmentations performed on Momentum and Nesterov GBMs.

Algorithm 1 Delta-Bar-Delta Boosting

Input: Dataset (xᵢ, yᵢ)_{{i = 1, . . . , n}}, learning rate η, Increase rate κ, decrease factor ϕ,
minimum learning rate Γₘᵢₙ, maximum learning rate Γₘₐₓ
Require: η > 0, κ > 0, 0 < ϕ < 1, Γₘᵢₙ ≤ η ≤ Γₘₐₓ
Initialize: F⁰(x) = f⁰(x) = 0; learning rate per data point [ηᵢ⁰ = η]_{{i = 1, . . . , n}}
for m = 1 to M do
$Compute pseudo residual : {ρ}_{i}^{m} = - {[ \frac{\partial l ( ( {y}_{i} , {F}^{m - 1} ( {x}_{i} ) )}{\partial {F}^{m - 1} ( {x}_{i} )} ]}_{( i = 1 , … , n )}$

| | |
|---|---|
| Fit weak learners f^{m} = argmin _{f ϵ} [symbol] Σᵢ₌₁ [symbol] L(ρᵢ, f(xᵢ)) | [symbol] Standard GBM Training |
| for i = 1 to n do | |
| Update learning rate: | [symbol] Our DBD Enhancement |

```
        ${η}_{i}^{m} = \{ \begin{matrix}min ( {η}_{i}^{m - 1} + κ , {Γ}_{max} ) & if {f}^{m - 1} ( {x}_{i} ) {f}^{m} ( {x}_{i} ) > 0 \\ max ( {ϕη}_{i}^{m - 1} , {Γ}_{min} ) & if {f}^{m - 1} ( {x}_{i} ) {f}^{m} ( {x}_{i} ) < 0 \\ {η}_{i}^{m - 1} & otherwise\end{matrix}$
  end for
  Update model: F^{m}(xᵢ) = F^{m-1}(xᵢ) + ηᵢ^{m}f^{m}(xᵢ)
end for
Output: F = F^{M} [symbol]
indicates data missing or illegible when filed
```

### An Embodiment of DBD Boosting

In the above, M a maximum number of iterations, L is the loss across the entire data set, and l is the loss for individual data points. The learning parameter ηᵢ^{m} is as defined above in the introduction to DBD Boosting.

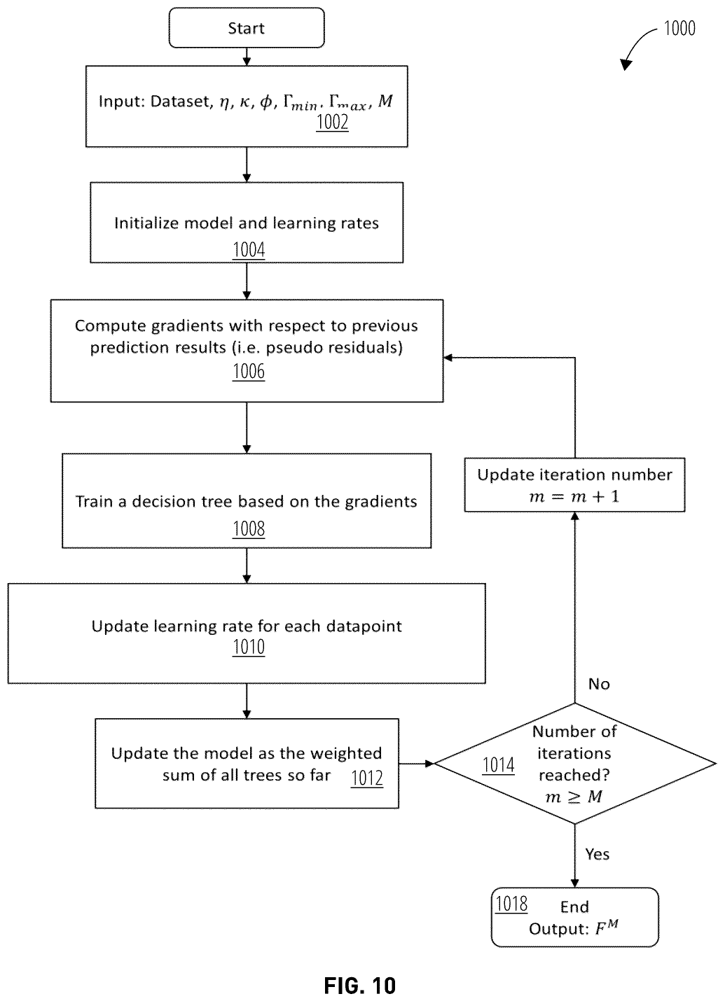

FIG. 10 illustrates a block diagram 1000 of DBD Boosting in accordance with one embodiment.

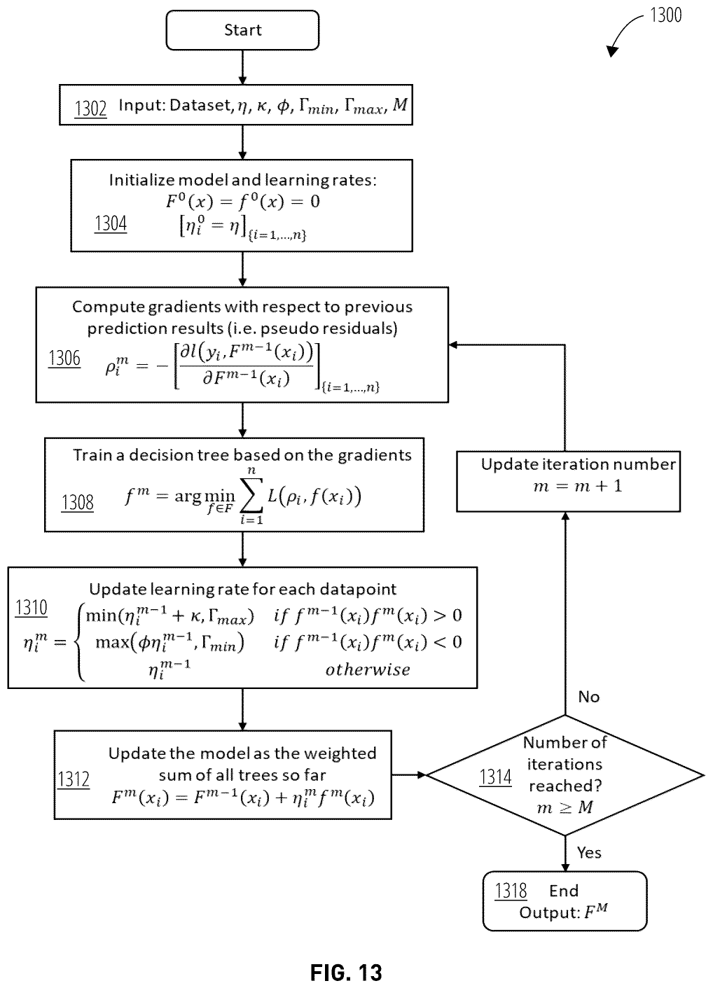

At block 1002, a dataset is input, along with a learning rate (η), an increase rate (κ), a decrease factor (ϕ), a minimum learning rate (Γₘᵢₙ), a maximum learning rate (Γₘₐₓ), and a maximum number of iterations (M). There can be restrictions on one or more of these entities; examples of restrictions can include: η>0, κ>0, 0<ϕ<1, Γₘᵢₙ<η<Γₘₐₓ. Next, at block 1004, the model and learning rates are initialized. An example of initialization is illustrated in FIG. 13. Next, at block 1006, gradients are computed with respect to previous prediction results (i.e. pseudo residuals). An example of determining pseudo-residuals is illustrated in FIG. 13. Next, at block 1008, a decision tree is trained based on the gradients. An example of training a decision tree is illustrated in FIG. 13. Next, at block 1010, the learning rate at each data point is updated, such that: each learning rate increases linearly if respective pseudo residual maintains a direction across sequential training iterations; and each learning rate decreases exponentially as the respective pseudo residual changes direction across sequential training iterations. An example of updating the learning rate at each data point is illustrated in FIG. 13. Next, at block 1012, the model is updated as the weighted sum of all trees thus far in the iteration, by using the updated learning rate in block 1010. An example of updating the model is illustrated in FIG. 13.

Thereafter, there is an iterative process of: computing pseudo-residuals (block 1006), training a decision tree (block 1008), updating the learning rate for each data point (block 1010) and updating the model (block 1012) until the number of iterations reaches a pre-set maximum value ‘M’ (‘yes at decision block 1014), at which point the output is a trained model (block 1018).

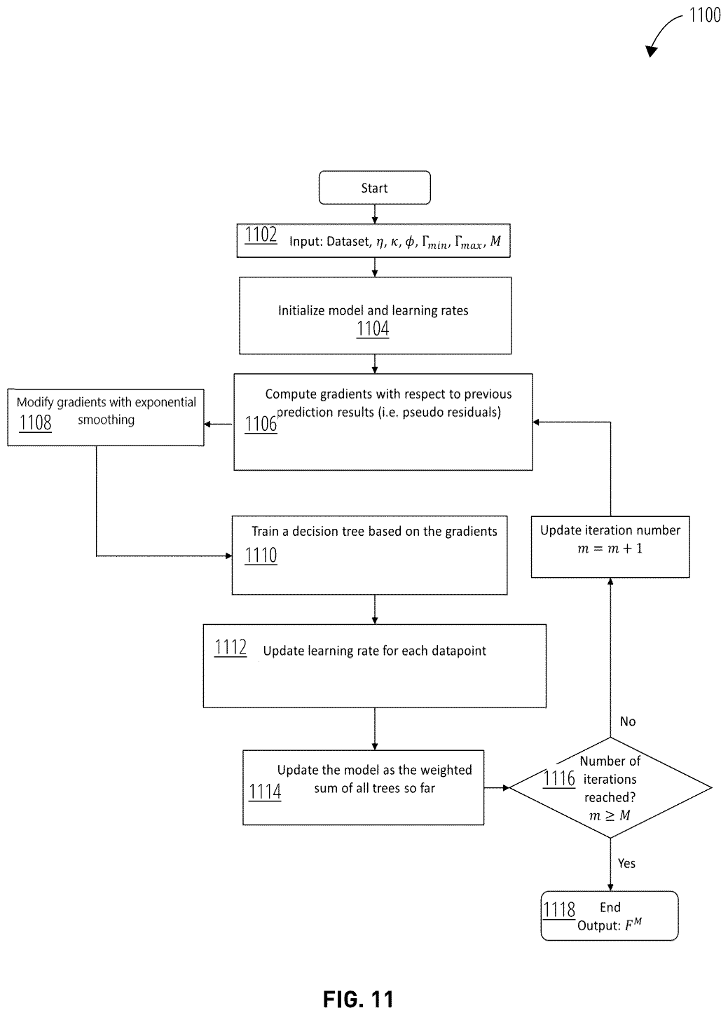

FIG. 11 illustrates a block diagram 1100 in accordance with one embodiment of Delta-Bar-Delta Momentum boosting. FIG. 11 is a variation of FIG. 10, in that it includes an extra block 1108 during which the gradients are modified with exponential smoothing, after the gradients are computed with respect to previous prediction results at block 1106. Once the gradients are modified with exponential smoothing at block 1108, a decision tree is trained based on the modified gradients at block 1110.

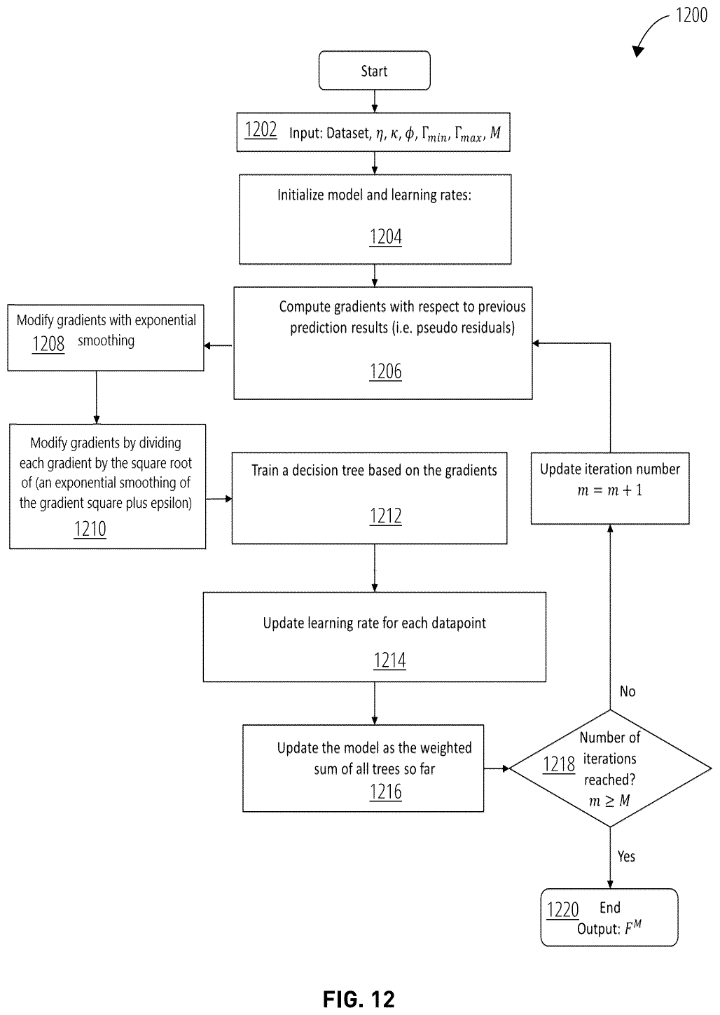

FIG. 12 illustrates a block diagram 1200 in accordance with one embodiment of Delta-Bar-Delta Nesterov boosting. FIG. 12 is a variation of FIG. 10, in that it includes two extra blocks 1208 and 1210. After the gradients are computed with respect to previous prediction results at block 1206, the gradients are modified with exponential smoothing at block 1208, followed by block 1210, at which the gradients are modified by dividing each gradient by the square root of (an exponential smoothing of the gradient squared plus epsilon). Once the gradients are modified at block 1210, a decision tree is trained based on the modified gradients at block 1212.

In block 1210, each gradient ‘g’ is divided by \sqrt{E[g²]+∈}, where ‘E’ is an exponentially smoothed term for g² and ‘∈’ is of the order 10⁻⁸; ‘∈’ can be included within the square root to offset a situation where ‘E’ is zero.

FIG. 13 illustrates a block diagram 1100 of DBD Boosting in accordance with one embodiment. FIG. 13 illustrates an embodiment of DBD Boosting in which further limitations are placed on a number of blocks shown in FIG. 10.

At block 1302, a dataset is input, along with a learning rate (η), an increase rate (κ), a decrease factor (ϕ), a minimum learning rate (Γₘᵢₙ), a maximum learning rate (Γₘₐₓ), and a maximum number of iterations (M). There can be restrictions on one or more of these entities; examples of restrictions can include: η>0, κ>0, 0<ϕ<1, Γₘᵢₙ<η<Γₘₐₓ.

Next, at block 1304, the model and learning rates are initialized, as denoted by F⁰(x) and ηᵢ⁰. Next, at block 1306, gradients are computed with respect to previous prediction results (i.e. pseudo residuals), as denoted by ρᵢ^{m} (‘m’ denoting the iteration number). Next, at block 1308, a decision tree is trained based on the gradients. The training is denoted by f^{m}. Next, at block 1310, the learning rate at each data point is updated, as denoted by ηᵢ^{m}. Next, at block 1312, the model is updated as the weighted sum of all trees thus far in the iteration, by using the updated learning rate in block 1310. The updated model is denoted by F^{m}(xᵢ).

Thereafter, there is an iterative process of: computing pseudo-residuals (block 1306), training a decision tree (block 1308), updating the learning rate for each data point (block 1310) and updating the model (block 1312) until the number of iterations reaches a pre-set maximum value ‘M’ (‘yes at decision block 1314), at which point the output is a trained model (block 1318), denoted by F^{M}.

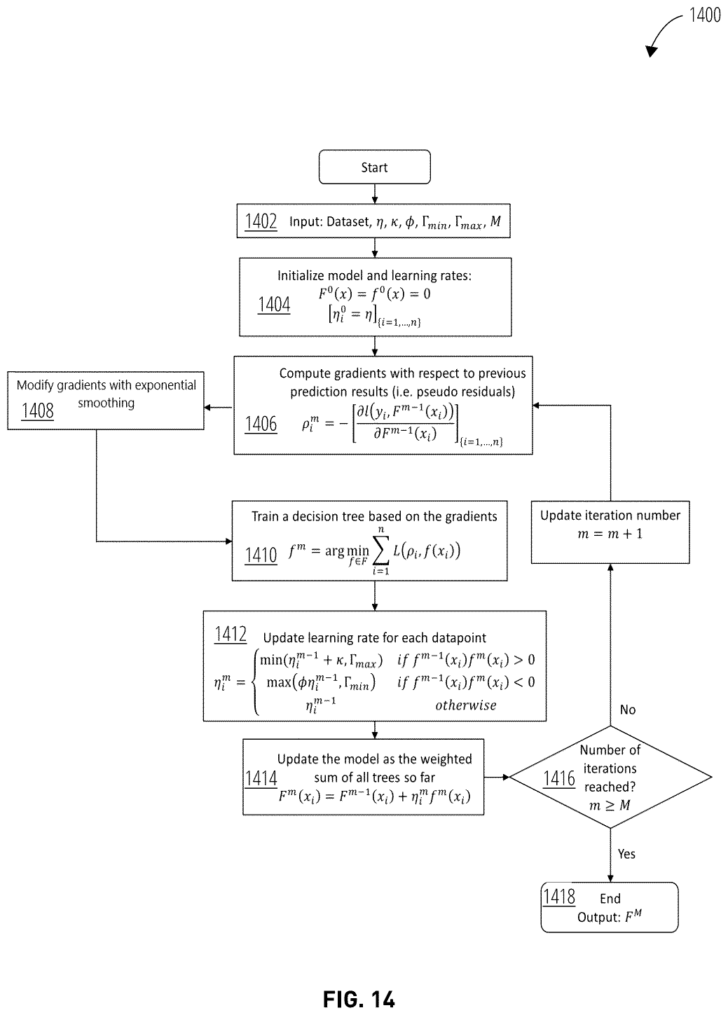

FIG. 14 illustrates a block diagram 1400 in accordance with one embodiment of Delta-Bar-Delta Momentum boosting. FIG. 14 is a variation of FIG. 13, in that it includes an extra block 1308 during which the gradients are modified with exponential smoothing, after the gradients are computed with respect to previous prediction results at block 1406. Once the gradients are modified with exponential smoothing at block 1408, a decision tree is trained based on the modified gradients at block 1410.

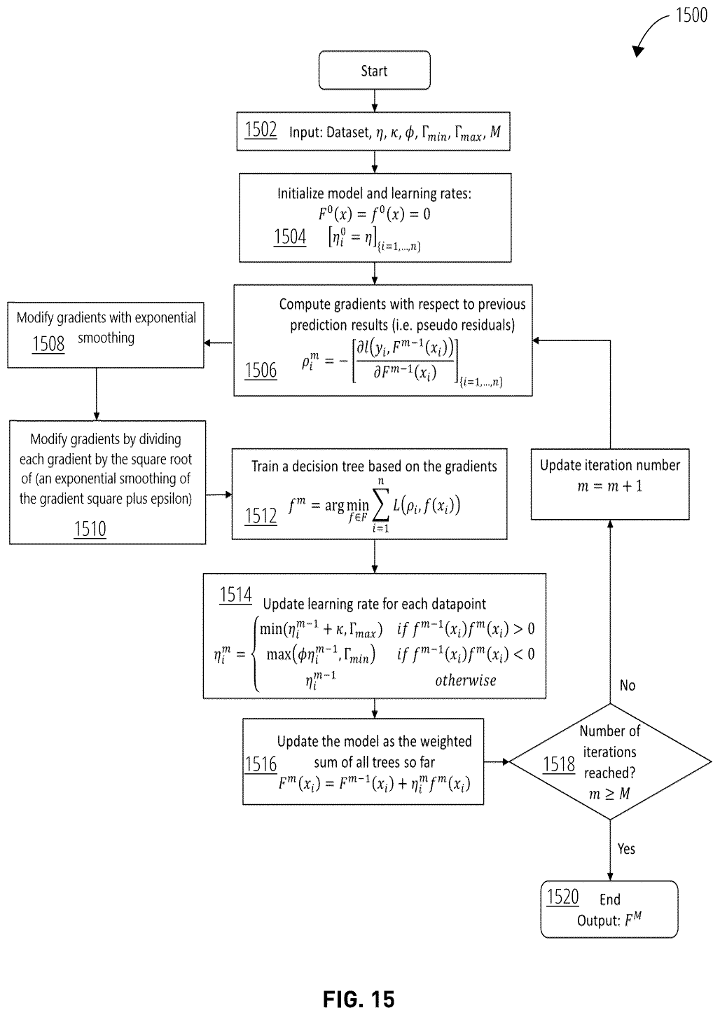

FIG. 15 illustrates a block diagram 1500 in accordance with one embodiment of Delta-Bar-Delta Nesterov boosting. FIG. 15 is a variation of FIG. 13, in that it includes two extra blocks 1508 and 1510. After the gradients are computed with respect to previous prediction results at block 1506, the gradients are modified with exponential smoothing at block 1508, followed by block 1510, at which the gradients are modified by dividing each gradient by the square root of (an exponential smoothing of the gradient squared plus epsilon). Once the gradients are modified at block 1510, a decision tree is trained based on the modified gradients at block 1512.

In block 1510, each gradient ‘g’ is divided by \sqrt{E[g²]+∈}, where ‘E’ is an exponentially smoothed term for g² and ‘∈’ is of the order 10⁻⁸; ‘∈’ can be included within the square root to offset a situation where ‘E’ is zero.

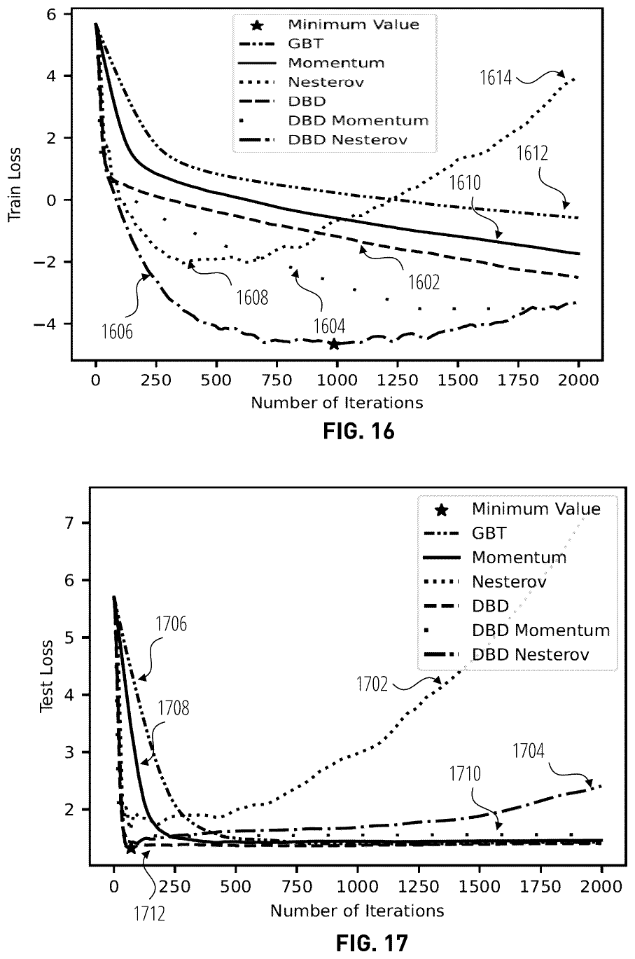

FIG. 16-FIG. 17 demonstrate performance improvements of the disclosed systems and methods for accelerated tree learning compared to benchmark models.

FIG. 16 illustrates train loss versus number of iterations in accordance with one embodiment. In particular, FIG. 16 demonstrates the loss curves for different models during training time, in which GBT 1612 is the benchmark model. Each loss curve in FIG. 16 indicates the amount of error between predicted output of the model and the expected output from the dataset. The lower the loss curve, the better.

As shown in FIG. 16, three models used in the disclosed systems and method (DBD 1602, DBD Momentum 1604 and DBD Nesterov 1606) each show a marked improvement over the benchmark GBT 1612 model and Momentum 1610 model. These models are DBD 1602, DBD Momentum 1604 and DBD Nesterov 1606, with the DBD Nesterov 1606 model being the best in terms of training.

It should be noted the relative improvement of the use of DBD in FIG. 16. For example, DBD 1602 shows a marked improvement over GBT 1612; DBD Momentum 1604 shows a marked improvement over Momentum 1610, while DBD Nesterov 1606 shows a marked improvement over Nesterov 1608. It is DBD Nesterov 1606 that exhibits a Train Loss minimum at about 1000 iterations, well before any of the non-DBD methods (i.e. GBT 1612, Momentum 1610 and Nesterov 1608), thus illustrating the enhancement of computer efficiency and resources that results from the processes disclosed herein, including the exemplary process shown in FIG. 10.

FIG. 17 illustrates test loss versus number of iterations in accordance with one embodiment. In particular, FIG. 17 demonstrates the loss curves for different models during testing time (using data samples that were never seen before by the model during training time).

In FIG. 17, each loss curve indicates the amount of error between predicted output of the model and the expected output from the dataset. The lower the loss curve, the better. As shown in FIG. 17, the three models used in the disclosed systems and method (DBD 1602, DBD Momentum 1604 and DBD Nesterov 1606) each show a marked improvement over the benchmark GBT 1706 model over the first 300 iterations or so, with the DBD 1712, DBD Momentum 1710 and DBD Nesterov 1704 models being the best in terms of training.

In FIG. 17, while the loss curve of DBD Nesterov 1704 eventually rises above the loss curve of GBT 1706, the DBD Nesterov 1704 curve already reaches a minimum loss at a much earlier iteration at about 100 iterations. It should be noted that both the DBD 1712 and DBD Momentum 1710 models also reach their respective minimum at about 100 iteration. This means that the performance of the each DBD model (that is, DBD Nesterov 1704, DBD Momentum 1710 and DBD 1712) use far fewer the number of iterations used by GBT. This is a clear illustration of the enhancement of computer efficiency and resources that results from the processes disclosed herein, including the exemplary processes shown in FIG. 10.

FIG. 16 and FIG. 17 demonstrate performance on long running optimization. The DBD variants for GBM and momentum GBM are stable. The over-fitting of Nesterov GBM variants is to be expected and has been reported in previous research. Interestingly, DBD-enhanced Nesterov GBM overfits more slowly than its counterpart, suggesting it imposes some kind of regularizing effect.

As illustrated, Delta-Bar-Delta Boosting, an adaptive learning rate algorithm for gradient boosting can be easily combined with other optimization algorithms such as Momentum and Nesterov. DBD Boosting demonstrates improved convergence speed on a variety of different datasets and tasks.

### Experiment Setup

The DBD boosting method is evaluated against the current baseline GBMs, Momentum-enhanced GBMs, and Nesterov-enhanced GBMs. The experimental setup follows that outlined in a previous study by Lu et al. (H. Lu, S. P. Karimireddy, N. Ponomareva, and V. Mirrokni. “Accelerating gradient boosting machines”. In: International conference on artificial intelligence and statistics. PMLR. 2020, pp. 516-526), to ensure a thorough and comparable analysis.

Table 1 describes the statistics of the datasets that are employed. Negative Log Likelihood (NLL) is used for classification tasks (categorical output) and Mean Squared Error (MSE) is used for regression tasks (numerical output). Hyperparameter tuning is incorporated at all reported number of trees to assess each algorithm's performance. For each dataset, data is first partitioned into 80/20% train/test splits. The training set is further partitioned using 5-fold cross validation into 80% (64% overall) and 20% (16% overall) training and validation splits. Hyperparameters are tuned across the validation splits and report the overall error on the test split. The implementation of cross-validation ensures an accurate assessment of the model's generalization capabilities. Trees of depth 3 are used as weak learners; each algorithm is evaluated with 30, 50, and 100 iterations, aligning with the setup from the previous study by Lu et al. The term η⁰ was set to 0.01 and employed RandomizedSearchCV from scikit-learn for hyperparameter tuning. For the base model, the following are tuned: min_gain_to_split∈{10, 5, 2, 1, 0.5, 0.1, 0.01, 0.001, le−4, le−5} and l2_regularizer_on_leaves∈{0.01, 0.1, 0.5, 1, 2, 4, 8, 16, 32, 64}. Additionally, for the DBD boosting algorithms, the following are tuned: (Γₘᵢₙ, Γₘₐₓ)∈{(8, 8⁻¹), (10, 10⁻¹)}, κ∈{0.02Γₘₐₓ, 0.05Γₘₐₓ, 0.08Γₘₐₓ}, and ϕ∈{1.2⁻¹, 1.5⁻¹, 2⁻¹}.

TABLE 1
Statistics of the real datasets used

| Dataset | task | # samples | # features |
|---|---|---|---|
| a1a | classification | 1605 | 123 |
| diabetes | classification | 768 | 8 |
| w1a | classification | 2477 | 300 |
| housing | regression | 506 | 13 |
| mpg | regression | 392 | 7 |
| bodyfat | regression | 262 | 14 |

### Results

TABLE 2
Test performance after hyper-parameter tuning.

| # trees | Dataset | CBT | Momentum | Nesterov | DBD | DBD Momentum | DBD Nesterov |
|---|---|---|---|---|---|---|---|
| 30 | a1a | [symbol] | 0.636280 | [symbol] | [symbol] | 0.467455 | 0.523988 |
| | diabetes | 0.665151 | 0.647462 | [symbol] | [symbol] | 0.513461 | [symbol] |
| | w1a | [symbol] | [symbol] | [symbol] | [symbol] | 0.259584 | 0.379445 |
| | housing | [symbol] | [symbol] | [symbol] | [symbol] | [symbol] | [symbol] |
| | mpg | [symbol] | 124.84644 | [symbol] | 10.037104 | 5.950520 | 11.872179 |
| | bodyfat | 0.304097 | [symbol] | [symbol] | 0.003371 | 0.000084 | 0.005283 |
| 50 | a1a | [symbol] | [symbol] | [symbol] | [symbol] | 0.413725 | [symbol] |
| | diabetes | [symbol] | [symbol] | [symbol] | [symbol] | 0.473711 | 0.491178 |
| | w1a | [symbol] | [symbol] | [symbol] | [symbol] | 0.180320 | [symbol] |
| | housing | 116.777698 | [symbol] | [symbol] | [symbol] | [symbol] | [symbol] |
| | mpg | [symbol] | [symbol] | [symbol] | [symbol] | [symbol] | [symbol] |
| | bodyfat | [symbol] | [symbol] | [symbol] | [symbol] | 0.000020 | 0.000025 |
| 100 | a1a | [symbol] | [symbol] | 0.369594 | [symbol] | 0.377161 | [symbol] |
| | diabetes | 0.614572 | [symbol] | 0.441791 | [symbol] | [symbol] | 0.433251 |
| | w1a | [symbol] | [symbol] | [symbol] | [symbol] | [symbol] | 0.108292 |
| | housing | [symbol] | [symbol] | [symbol] | 3.502531 | 3.887929 | [symbol] |
| | mpg | [symbol] | [symbol] | [symbol] | [symbol] | 4.944793 | [symbol] |
| | bodyfat | 0.074450 | 0.012126 | 0.000031 | 0.000022 | 0.000020 | 0.000024 |

[symbol]

indicates data missing or illegible when filed

Table 2 demonstrates error on the test set after performing hyperparameter tuning. It is seen that in the early iterations {30, 50}, DBD-enhanced Momentum GBM outperforms almost all other algorithms. It is only at the 100-th iteration where DBD-enhanced Nesterov GBM begins to overtake DBD-enhanced Momentum GBM. However, with the exception of Nesterov GBM at the 100-th iteration for the “ala” dataset, all DBD variants outperform their non-adaptive counterparts.

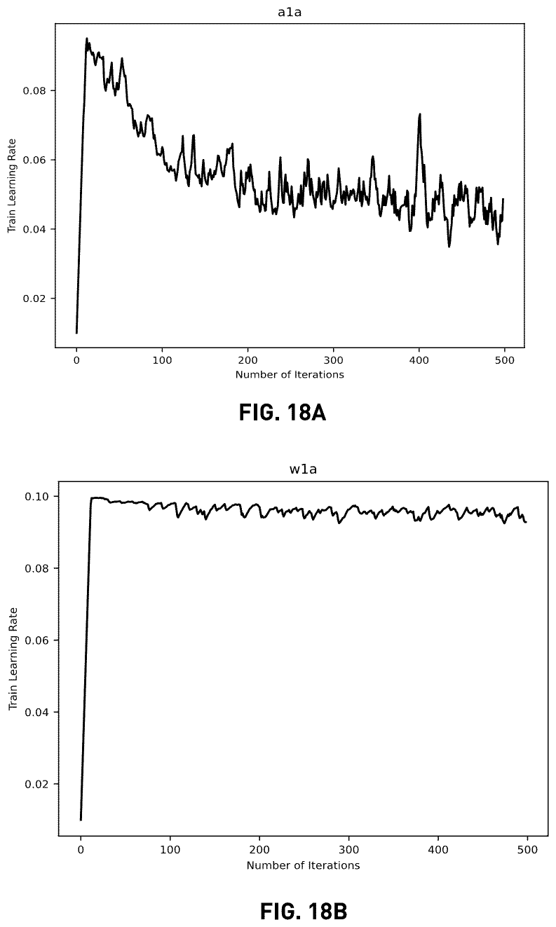

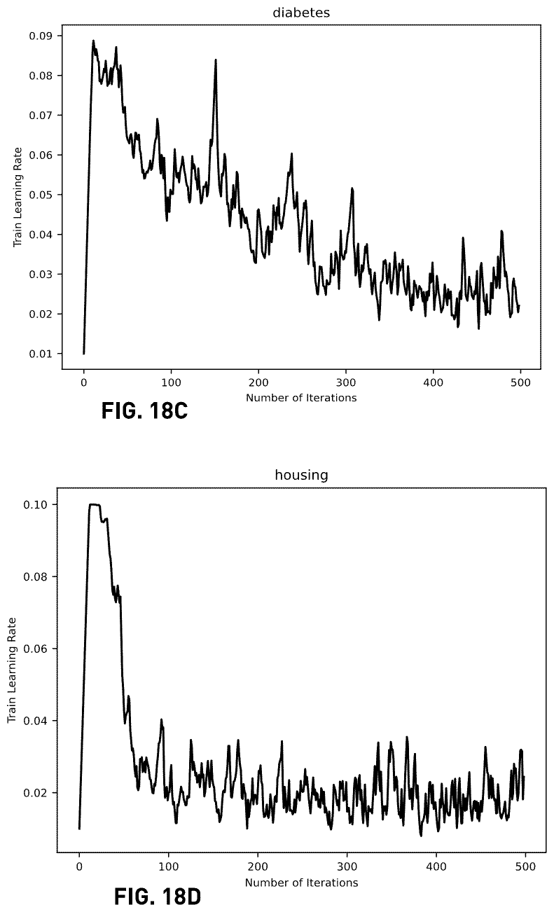

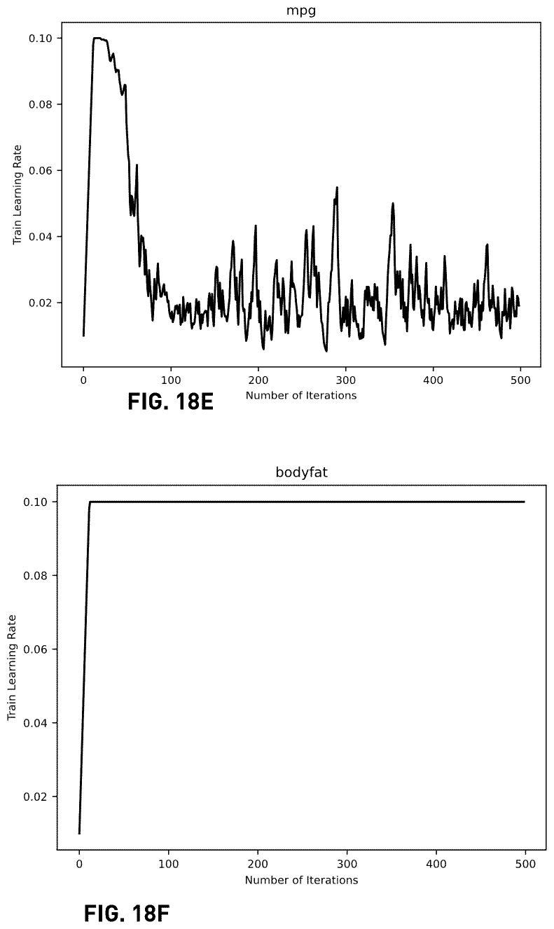

FIG. 18A illustrates training learning rate versus number of iterations using dataset ala. There is a steep increase in the training learning rate within the first 30 or so iterations. The training learning rate then descends and asymptotically levels off at around 0.05.

FIG. 18B illustrates training learning rate versus number of iterations using dataset wla. There is a steep increase in the training learning rate within the first 40 or so iterations. The training learning rate then levels off at around 0.9.

FIG. 18C illustrates training learning rate versus number of iterations using dataset diabetes. There is a steep increase in the training learning rate within the first 30 or so iterations. The training learning rate then descends up until 500 iterations.

FIG. 18D illustrates training learning rate versus number of iterations using dataset housing. There is a steep increase in the training learning rate within the first 30 or so iterations. The training learning rate then descends sharply until about 80 iterations, and then stays within a range of between 0.01-0.04 until the 500th iteration.

FIG. 18E illustrates training learning rate versus number of iterations using dataset mpg. There is a steep increase in the training learning rate within the first 30 or so iterations. The training learning rate then descends sharply until about 100 iterations, and then stays within a range of between 0.01-0.05 until the 500th iteration.

FIG. 18F illustrates training learning rate versus number of iterations using dataset body fat. There is a steep increase in the training learning rate within the first 40 or so iterations. The training learning rate then stays flat at about 0.10 until the 500th iteration.

This difference in performance may be explained by analyzing FIG. 18A-FIG. 18F, where it is seen in early iterations that there is a consistent learning rate increase. This is because most of the gradients are in the same direction during early iterations. At later iterations, where the model can no longer easily distinguish splits, variation in learning rates are observed. Notice that for bodyfat (FIG. 18F) and wla (FIG. 18B), only an initial increase is observed with little to no change in the learning rate afterwards. Referring back to Table 2, it is seen that these datasets have the lowest and second lowest loss values respectively. This behavior may be a result of early convergence. When the model is caught in a flat regional minima, the gradients is expected to diminish to zero. If the gradient diminishes faster than the maximum learning rate can step, it is as if there is a stationary locale within the flat region. Consequently, the gradients would always be in the same direction resulting in a maxed learning rate.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computing apparatus comprising:
a processor; and
a memory storing instructions that, when executed by the processor, configure the apparatus to:
(a) obtain, by the processor, training data and testing data;
(b) obtain, by the processor, one or more gradients with respect to previous prediction results;
(c) train, by the processor, a decision tree based on the one or more gradients;
(d) apply, by the processor, a weighted sum of an output of each tree;
(e) obtain, by the processor, an overall prediction result;
repeat steps (b) through (e) until convergence,
wherein in steps (b) through (e), the apparatus is configured to execute at least one of the following:
(b.1) modify, by the processor, the one or more gradients with exponential smoothing;
(b.2) modify, by the processor, the one or more gradients based on an exponential smoothing of the square of the one or more gradients; and
(c.1) modify, by the processor, one or more learning rates by comparing with the previous prediction results.

2. The computing apparatus of claim 1, wherein the apparatus is further configured to:
(a) obtain, by the processor, the training data and the testing data;
(b) obtain, by the processor, one or more gradients with respect to previous prediction results;
(b.1) modify, by the processor, the one or more gradients with exponential smoothing;
(c) train, by the processor, a decision tree based on the one or more gradients;
(d) apply, by the processor, a weighted sum of an output of each tree;
(e) obtain, by the processor, an overall prediction result; and
repeat steps (b) through (e) until convergence.

3. The computing apparatus of claim 1, wherein the apparatus is further configured to:
(a) obtain, by the processor, the training data and the testing data;
(b) obtain, by the processor, one or more gradients with respect to previous prediction results;
(c) train, by the processor, a decision tree based on the one or more gradients;
(c.1) modify, by the processor, one or more learning rates by comparing with the previous prediction results;
(d) apply, by the processor, a weighted sum of an output of each tree;
(e) obtain, by the processor, an overall prediction result; and
repeat steps (b) through (e) until convergence.

4. The computing apparatus of claim 1, wherein the apparatus is further configured to:
(a) obtain, by the processor, the training data and the testing data;
(b) obtain, by the processor, one or more gradients with respect to previous prediction results;
(b.1) modify, by the processor, the one or more gradients with exponential smoothing;
(c) train, by the processor, a decision tree based on the one or more gradients;
(c.1) modify, by the processor, one or more learning rates by comparing with the previous prediction results;
(d) apply, by the processor, a weighted sum of an output of each tree;
(e) obtain, by the processor, an overall prediction result; and
repeat steps (b) through (e) until convergence.

5. The computing apparatus of claim 1, wherein the apparatus is further configured to:
(a) obtain, by the processor, the training data and the testing data;
(b) obtain, by the processor, one or more gradients with respect to previous prediction results;
(b.2) modify, by the processor, the one or more gradients based on an exponential smoothing of the square of the one or more gradients;
(c) train, by the processor, a decision tree based on the one or more gradients;
(d) apply, by the processor, a weighted sum of an output of each tree;
(e) obtain, by the processor, an overall prediction result; and
repeat steps (b) through (e) until convergence.

6. A non-transitory computer-readable storage medium, the computer-readable storage medium including instructions that when executed by a computer, cause the computer to,
(a) obtain, by a processor, training data and testing data;
(b) obtain, by the processor, one or more gradients with respect to previous prediction results;
(c) train, by the processor, a decision tree based on the one or more gradients;
(d) apply, by the processor, a weighted sum of an output of each tree;
(e) obtain, by the processor, an overall prediction result;
repeat steps (b) through (e) until convergence,
wherein in steps (b) through (e), the computer is configured to execute at least one of the following:
(b.1) modify, by the processor, the one or more gradients with exponential smoothing;
(b.2) modify, by the processor, the one or more gradients based on an exponential smoothing of the square of the one or more gradients; and
(c.1) modify, by the processor, one or more learning rates by comparing with the previous prediction results.

7. The non-transitory computer-readable storage medium of claim 6, wherein the computer is further configured to:
(a) obtain, by the processor, the training data and the testing data;
(b) obtain, by the processor, one or more gradients with respect to previous prediction results;
(b.1) modify, by the processor, the one or more gradients with exponential smoothing;
(c) train, by the processor, a decision tree based on the one or more gradients;
(d) apply, by the processor, a weighted sum of an output of each tree;
(e) obtain, by the processor, an overall prediction result; and
repeat steps (b) through (e) until convergence.

8. The non-transitory computer-readable storage medium of claim 6, wherein the computer is further configured to:
(a) obtain, by the processor, the training data and the testing data;
(b) obtain, by the processor, one or more gradients with respect to previous prediction results;
(c) train, by the processor, a decision tree based on the one or more gradients;
(c.1) modify, by the processor, one or more learning rates by comparing with the previous prediction results;
(d) apply, by the processor, a weighted sum of an output of each tree;
(e) obtain, by the processor, an overall prediction result; and
repeat steps (b) through (e) until convergence.

9. The non-transitory computer-readable storage medium of claim 6, wherein the computer is further configured to:
(a) obtain, by the processor, the training data and the testing data;
(b) obtain, by the processor, one or more gradients with respect to previous prediction results;
(b.1) modify, by the processor, the one or more gradients with exponential smoothing;
(c) train, by the processor, a decision tree based on the one or more gradients;
(c.1) modify, by the processor, one or more learning rates by comparing with the previous prediction results;
(d) apply, by the processor, a weighted sum of an output of each tree;
(e) obtain, by the processor, an overall prediction result; and
repeat steps (b) through (e) until convergence.

10. The non-transitory computer-readable storage medium of claim 6, wherein the computer is further configured to:
(a) obtain, by the processor, the training data and the testing data;
(b) obtain, by the processor, one or more gradients with respect to previous prediction results;
(b.2) modify, by the processor, the one or more gradients based on an exponential smoothing of the square of the one or more gradients;
(c) train, by the processor, a decision tree based on the one or more gradients;
(d) apply, by the processor, a weighted sum of an output of each tree;
(e) obtain, by the processor, an overall prediction result; and
repeat steps (b) through (e) until convergence.

11. A computer-implemented method for accelerated tree learning, the method comprising:
(a) obtaining, by a processor, training data and testing data;
(b) obtaining, by the processor, one or more gradients with respect to previous prediction results;
(c) training, by the processor, a decision tree based on the one or more gradients;
(d) applying, by the processor, a weighted sum of an output of each tree;
(e) obtaining, by the processor, an overall prediction result;
repeating steps (b) through (e) until convergence,
wherein steps (b) through (e) include at least one of the following:
(b.1) modifying, by the processor, the one or more gradients with exponential smoothing;
(b.2) modifying, by the processor, the one or more gradients based on an exponential smoothing of the square of the one or more gradients; and
(c.1) modifying, by the processor, one or more learning rates by comparing with the previous prediction results.

12. The computer-implemented method of claim 11, comprising:
(a) obtaining, by the processor, the training data and the testing data;
(b) obtaining, by the processor, one or more gradients with respect to previous prediction results;
(b.1) modifying, by the processor, the one or more gradients with exponential smoothing;
(c) training, by the processor, a decision tree based on the one or more gradients;
(d) applying, by the processor, a weighted sum of an output of each tree;
(e) obtaining, by the processor, an overall prediction result; and
repeating steps (b) through (e) until convergence.

13. The computer-implemented method of claim 11, comprising:
(a) obtaining, by the processor, the training data and the testing data;
(b) obtaining, by the processor, one or more gradients with respect to previous prediction results;
(c) training, by the processor, a decision tree based on the one or more gradients;
(c.1) modifying, by the processor, one or more learning rates by comparing with the previous prediction results;
(d) applying, by the processor, a weighted sum of an output of each tree;
(e) obtaining, by the processor, an overall prediction result; and
repeating steps (b) through (e) until convergence.

14. The computer-implemented method of claim 11, comprising:
(a) obtaining, by the processor, the training data and the testing data;
(b) obtaining, by the processor, one or more gradients with respect to previous prediction results;
(b.1) modifying, by the processor, the one or more gradients with exponential smoothing;
(c) training, by the processor, a decision tree based on the one or more gradients;
(c.1) modifying, by the processor, one or more learning rates by comparing with the previous prediction results;
(d) applying, by the processor, a weighted sum of an output of each tree;
(e) obtaining, by the processor, an overall prediction result; and
repeating steps (b) through (e) until convergence.

15. The computer-implemented method of claim 11, comprising:
(a) obtaining, by the processor, the training data and the testing data;
(b) obtaining, by the processor, one or more gradients with respect to previous prediction results;
(b.2) modifying, by the processor, the one or more gradients based on an exponential smoothing of the square of the one or more gradients;
(c) training, by the processor, a decision tree based on the one or more gradients;
(d) applying, by the processor, a weighted sum of an output of each tree;
(e) obtaining, by the processor, an overall prediction result; and
repeating steps (b) through (e) until convergence.

16. A computing apparatus comprising:
a processor; and
a memory storing instructions that, when executed by the processor, configure the apparatus to:
update, by the processor, each learning rate of a respective parameter during each iteration of training a decision tree model, until a fully-trained model is obtained, wherein:
each parameter has a unique learning rate;
each learning rate varies over the training;
each learning rate increases linearly as a respective pseudo residual maintains a direction across sequential training iterations; and
each learning rate decreases exponentially as the respective pseudo residual changes direction across sequential training iterations.

17. The computing apparatus of claim 16 configured to:
receive, by the processor, a training data set, a learning rate, an increase rate applied to each learning rate, a decrease factor, a minimum learning rate (Γₘᵢₙ), a maximum learning rate (Γₘₐₓ), and a maximum number of iterations (M) for the training;
initialize, by the processor, the decision tree model and a plurality of learning rates, each learning rate associated with a respective data point in the data set;
iterate, by the processor, through the maximum number of iterations until the fully trained model is obtained, the following:
evaluate, by the processor, each pseudo residual associated with the respective data point;
train, by the processor, the decision tree based on each pseudo residual;
update, by the processor, each learning rate associated with the respective data point; and
update the decision tree model as a weighted sum of a current state of all trees in the decision tree model.

18. The computing apparatus of claim 16, wherein the apparatus is configured to incorporate Momentum-augmented gradient boosting.

19. The computing apparatus of claim 16, wherein the apparatus is configured to incorporate Nesterov Accelerated Gradient Boosting.
